(19) United States
(12) Patent Application Publication
(10) Pub. No.: US 2024/0172266 A1
(43) Pub. Date: May 23, 2024

(54) METHOD FOR INFORMATION FEEDBACK, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Yanan LIN, Dongguan (CN); Jing XU, Dongguan (CN); Yi ZHANG, Dongguan (CN)

(21) Appl. No.: 18/427,726

(22) Filed: Jan. 30, 2024

Related U.S. Application Data
(63) Continuation of application No. PCT/CN2021/125700, filed on Oct. 22, 2021.

(30) Foreign Application Priority Data
Sep. 16, 2021 (CN) 202111089120.X

(51) Int. Cl. H04W 72/56; H04W 72/0446; H04W 72/21; H04L 1/1829

(52) U.S. Cl. CPC H04W 72/56; H04W 72/0446; H04W 72/21; H04L 1/1854

(57) ABSTRACT

A method for information feedback, a terminal device, and a network device are provided. The method includes the following. Determine a first time unit for transmission of first feedback response information according to configuration information, where deferral transmission of the first feedback response information is supported. Transmit in a second time unit second feedback response information or transmit in the second time unit both the first feedback response information and the second feedback response information, in the case where no available transmission resource is in the first time unit and first information instructs the terminal device to retransmit in the second time unit the second feedback response information. The first time unit is the second time unit, or the first time unit is no later than the second time unit.

### CROSS-REFERENCE TO RELATED APPLICATION(S)

This application is a continuation of International Application No. PCT/CN2021/125700, filed Oct. 22, 2021, which claims priority to Chinese Patent Application No. 202111089120.X, filed Sep. 16, 2021, the entire disclosures of which are incorporated herein by reference.

### TECHNICAL FIELD

This disclosure relates to the field of communication technologies, and in particular, to a method for information feedback, a terminal device, and a network device.

### BACKGROUND

In a new radio (NR) system, in order to better support ultra-reliable low latency communication (URLLC) services, a network device may configure for a terminal device multiple sets of configurations for a semi-persistent scheduling physical downlink control channel (SPS PDSCH), and the terminal device transmits in a preconfigured time unit feedback response information for the SPS PDSCH. In order to avoid a reduction in system efficiency caused by dropping of the feedback response information, it is supported to defer transmission of the feedback response information to be performed in a certain time unit later than the preconfigured time unit.

Meanwhile, information transmission conditions also need to be fed back in order to ensure reliability of communication transmission. In mobile communications, information transmission between the terminal device and the network device may be performed in a hybrid automatic repeat request (HARQ) manner. The terminal device is required to retransmit HARQ feedback response information in the case where the network device fails to receive an HARQ codebook transmitted by the terminal device.

In the related art, transmission of the above two types of feedback response information are separately designed. At present, there is no solution on how to transmit in the same time unit the two types of feedback response information.

### SUMMARY

A method for information feedback, a terminal device, and a network device are provided in embodiments of disclosure.

According to an aspect of the disclosure, a method for information feedback is provided. The method is applied in a terminal device and includes the following. Determine a first time unit for transmission of first feedback response information according to configuration information. Deferral transmission of the first feedback response information is supported. Transmit in a second time unit second feedback response information or transmit in the second time unit both the first feedback response information and the second feedback response information, in the case where no available transmission resource is in the first time unit and first information instructs the terminal device to retransmit in the second time unit the second feedback response information. The first time unit is the second time unit, or the first time unit is no later than the second time unit.

According to an aspect of the disclosure, a terminal device is provided. The terminal device includes a transceiver, a processor coupled to the transceiver, and a memory storing a computer program which, when executed by the processor, causes the terminal device to perform the following. Determine a first time unit for transmission of first feedback response information according to configuration information. Deferral transmission of the first feedback response information is supported. Transmit in a second time unit second feedback response information or transmit in the second time unit both the first feedback response information and the second feedback response information, in the case where no available transmission resource is in the first time unit and first information instructs the terminal device to retransmit in the second time unit the second feedback response information. The first time unit is the second time unit, or the first time unit is no later than the second time unit.

According to an aspect of the disclosure, a network device is provided. The network device includes a transceiver, a processor coupled to the transceiver, and a memory storing a computer program which, when executed by the processor, causes the network device to perform the following. Transmit configuration information. The configuration information is used by a terminal device to determine a first time unit for transmission of first feedback response information. Deferral transmission of the first feedback response information is supported. Transmit first information. The first information is used for instructing the terminal device to retransmit in a second time unit second feedback response information. Receive in the second time unit the second feedback response information, where the second feedback response information is transmitted by the terminal device in the case where no available transmission resource is in the first time unit and the first information instructs the terminal device to retransmit in the second time unit the second feedback response information; or receive in the second time unit both the first feedback response information and the second feedback response information, where both the first feedback response information and the second time unit are transmitted by the terminal device in the case where no available transmission resource is in the first time unit and the first information instructs the terminal device to retransmit in the second time unit the second feedback response information. The first time unit is the second time unit, or the first time unit is no later than the second time unit.

Other features and aspects of the disclosed features will become apparent from the following detailed description, taken in conjunction with the accompanying drawings, which illustrate, by way of example, the features in accordance with implementations the disclosure. The summary is not intended to limit the scope of any implementations described herein.

### BRIEF DESCRIPTION OF THE DRAWINGS

In order to describe technical solutions in embodiments of the disclosure more clearly, the following will give a brief introduction to accompanying drawings required for describing embodiments. Apparently, the accompanying drawings hereinafter described merely illustrate some embodiments of the disclosure. Based on these drawings, those of ordinary skill in the art can also obtain other drawings without creative effort.

FIG. 1 is a block diagram illustrating a communication system provided in an exemplary embodiment of the disclosure.

FIG. 2 is a schematic diagram illustrating information transmission provided in an exemplary embodiment of the disclosure.

FIG. 3 is a schematic diagram illustrating information transmission provided in an exemplary embodiment of the disclosure.

FIG. 4 is a flow chart illustrating a method for information feedback provided in an exemplary embodiment of the disclosure.

FIG. 5 is a flow chart illustrating a method for information feedback provided in an exemplary embodiment of the disclosure.

FIG. 6 is a flow chart illustrating a method for information feedback provided in an exemplary embodiment of the disclosure.

FIG. 7 is a schematic diagram illustrating information transmission provided in an exemplary embodiment of the disclosure.

FIG. 8 is a flow chart illustrating a method for information feedback provided in an exemplary embodiment of the disclosure.

FIG. 9 is a schematic diagram illustrating information transmission provided in an exemplary embodiment of the disclosure.

FIG. 10 is a flow chart illustrating a method for information feedback provided in an exemplary embodiment of the disclosure.

FIG. 11 is a flow chart illustrating a method for information feedback provided in an exemplary embodiment of the disclosure.

FIG. 12 is a schematic diagram illustrating information transmission provided in an exemplary embodiment of the disclosure.

FIG. 13 is a structural diagram illustrating an apparatus for information feedback provided in an exemplary embodiment of the disclosure.

FIG. 14 is a structural diagram illustrating an apparatus for information feedback provided in an exemplary embodiment of the disclosure.

FIG. 15 is a structural diagram illustrating an apparatus for information feedback provided in an exemplary embodiment of the disclosure.

FIG. 16 is a structural diagram illustrating an apparatus for information feedback provided in an exemplary embodiment of the disclosure.

FIG. 17 is a structural diagram illustrating an apparatus for information feedback provided in an exemplary embodiment of the disclosure.

FIG. 18 is a structural diagram illustrating an apparatus for information feedback provided in an exemplary embodiment of the disclosure.

FIG. 19 is a structural diagram illustrating an apparatus for information feedback provided in an exemplary embodiment of the disclosure.

FIG. 20 is a structural diagram illustrating an apparatus for information feedback provided in an exemplary embodiment of the disclosure.

FIG. 21 is a schematic structural diagram illustrating a communication device provided in an exemplary embodiment of the disclosure.

### DETAILED DESCRIPTION

In order to make purposes, technical solutions, and advantages of the disclosure clearer, the following will further describe in detail embodiments of the disclosure with reference to accompanying drawings.

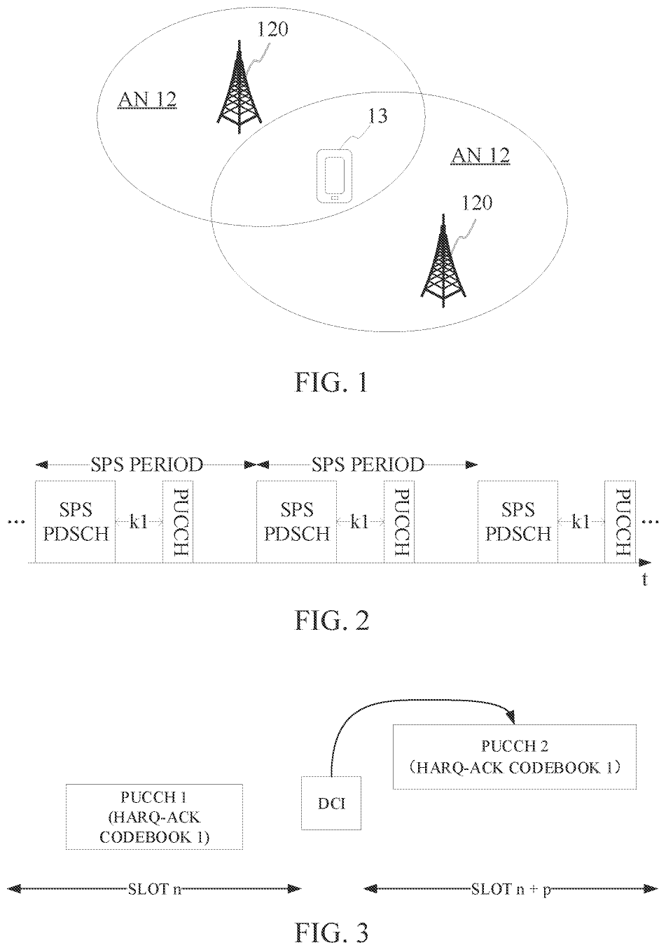

FIG. 1 is a block diagram illustrating a communication system provided in an exemplary embodiment of the disclosure. The communication system may include an access network (AN) 12 and a terminal device 13.

The AN 12 includes multiple network devices 120. The network device 120 may be a base station, where the base station is an apparatus that is deployed in the AN and used to provide a wireless communication function for the terminal device. The base station may include various forms of macro base stations, micro base stations, relay stations, access points (AP), etc. In systems with different radio access technologies, devices with a base-station function may have different names, for example, eNodeB (eNB) in a long-term evolution (LTE) system, or a gNodeB (gNB) in a fifth generation (5G) NR-based access to unlicensed spectrum (NR-U) system. With evolution of communication technology, illustration of “base station” may be changed. For sake of convenience in embodiments of the disclosure, the above apparatuses for providing wireless communication functions for the terminal device 13 are collectively referred to as AN devices.

The terminal device 13 may include various devices with a wireless communication function such as handheld devices, in-vehicle devices, wearable devices, and computing devices, or other processing devices coupled with a wireless modem, as well as various forms of user equipments (UEs), mobile stations (MSs), terminal devices, and the like. For convenience of illustration, the above-mentioned devices are collectively referred to as terminal devices. The network device 120 communicates with the terminal device 13 through a certain air-interface technology, such as a Uu interface.

Exemplarily, the terminal device 13 provided in embodiments of the disclosure may be configured to support an ultra-reliable low latency communication (URLLC) service.

Technical solutions in embodiments of the disclosure may be applicable to various communication systems, for example, a global system of mobile communication (GSM), a code division multiple access (CDMA) system, a wideband code division multiple access (WCDMA) system, a general packet radio service (GPRS), an LTE system, an LTE frequency division duplex (FDD) system, an LTE time division duplex (TDD) system, an advanced LTE (LTE-A) system, an NR system, an evolved system of the NR system, an LTE-based access to unlicensed spectrum (LTE-U) system, an NR-U system, a universal mobile telecommunication system (UMTS), a worldwide interoperability for microwave access (WiMAX) communication system, a wireless local area network (WLAN), a wireless fidelity (WiFi), a next-generation communication system, or other communication systems.

Generally speaking, a conventional communication system supports a limited number of connections and therefore is easy to implement. However, with development of communication technology, a mobile communication system not only supports conventional communication but also supports, for example, device to device (D2D) communication, machine to machine (M2M) communication, machine type communication (MTC), vehicle to vehicle (V2V) communication, and a vehicle to everything (V2X) system. Embodiments of the disclosure can also be applicable to these communication systems.

Hybrid automatic repeat request (HARQ) is a technology combining forward error correction (FEC) and automatic repeat request (ARQ). In mobile communications, a network device transmits downlink data to a terminal device in an HARQ manner.

After the terminal device receives the downlink data, the terminal device needs to transmit HARQ feedback information to the network device. Exemplarily, the HARQ feedback information includes acknowledgement (ACK)/negative acknowledgement (NACK), where ACK indicates correct reception, and NACK indicates incorrect reception. Optionally, the HARQ feedback information may indicate HARQ-ACK.

In an NR system, there are two data transmission modes: dynamic transmission and semi-persistent scheduling (SPS) transmission. A characteristic of the dynamic transmission is that parameters for each data transmission are indicated by corresponding downlink control information (DCI). Specifically, DCI contains information such as a physical resource used by a physical uplink shared channel (PDSCH), an HARQ process identity (ID), etc. A characteristic of the SPS transmission is that transmission resources and transmission modes are semi-persistently configured. DCI is used to activate/release corresponding SPS transmission, and once SPS transmission is activated, there is no need to schedule via physical-layer signaling subsequent transmission.

Optionally, the terminal device is configured with at most one set of SPS transmission parameters, where a shortest SPS transmission period is 10 ms. The network device configures some parameters for SPS transmission via higher-layer signaling, where the parameters mainly include a period, a time-domain resource, a physical uplink control channel (PUCCH) resource for transmission of ACK/NACK (referred to as HARQ-ACK in the protocol), etc.

Since the shortest SPS transmission period is 10 ms and a longest uplink-downlink switching period is 10 ms, i.e., at least one uplink transmission resource is determined to be in the period of 10 ms, independent feedback may be adopted for an SPS PDSCH, that is, one SPS PDSCH corresponds to one PUCCH, where the PUCCH carries ACK/NACK information for the SPS PDSCH. A PUCCH for ACK/NACK transmission configured by the network device for an SPS PDSCH is PUCCH format 0 or PUCCH format 1, where PUCCH format 0 or PUCCH format 1 can only carry at most 2-bit ACK/NACK information. Then the network device performs SPS activation or deactivation via DCI, and activation signaling may further indicate some parameters for SPS transmission, where the parameters include a frequency-domain resource, a feedback timing (k1), etc.

Referring to FIG. 2, activation signaling is transmitted only once, and once SPS transmission is activated, if there is no dynamic scheduling in the same time resource, the network device transmits an SPS PDSCH. Accordingly, the UE transmits ACK/NACK information for the SPS PDSCH.

Optionally, in order to better support URLLC transmission, the network device may configure for the terminal device multiple sets of SPS PDSCH configurations. The multiple sets of SPS PDSCH configurations may be different from each other in parameters and used for transmission of downlink services with different performance requirements. The multiple sets of SPS PDSCH configurations may be activated separately. The multiple sets of SPS PDSCH configurations may be activated simultaneously via one DCI. In addition, the SPS PDSCH period may be shortened to 1 ms. ACK/NACK information for an SPS PDSCH may not be transmitted, in the case where a time-domain resource determined for the SPS PDSCH according to a preconfigured feedback slot (k1) cannot be used for transmission of a PUCCH, e.g., a time-domain symbol occupied by the PUCCH is a downlink symbol.

In order to avoid a reduction in system efficiency caused by dropping of ACK/NACK for an SPS PDSCH, it may be supported to enhance feedback for an SPS PDSCH. Exemplarily, SPS ACK/NACK deferral transmission (e.g., SPS HARQ-ACK deferral) is supported.

In the case where an SPS PDSCH is received in slot/sub-slot n and ACK/NACK for the SPS PDSCH cannot be transmitted in slot/sub-slot n+k1 (for example, a time-domain resource occupied by a PUCCH carrying the ACK/NACK includes a time-domain symbol which is not used for uplink transmission), transmission of the ACK/NACK is deferred to be performed in target slot/sub-slot n+k1+kdefer, where k1 is preconfigured by the network device (for example, configured by a higher-layer signaling or indicated by activation signaling (e.g., DCI)). Target slot/sub-slot n+k1+kdefer is a first slot/sub-slot later than slot/sub-slot n+k1 and containing an available PUCCH resource(s), that is, in slot/sub-slot n+k1+kdefer, time-domain resources occupied by the PUCCH for transmission of the ACK/NACK are all available resources. A maximum deferral value in terms of k1+kdefer, that is, a maximum feedback deferral of SPS ACK/NACK for an SPS PDSCH, is configured for each set of SPS configuration via higher-layer signaling. SPS ACK/NACK may be dropped and transmission of the SPS ACK/NACK is not further deferred in the case where there is still no resource for transmission of the SPS ACK/NACK after the maximum feedback deferral.

To determine a target slot/sub-slot, the terminal device determines a PUCCH resource according to all ACK/NACK information that needs to be transmitted in a current slot/sub-slot. The current slot/sub-slot is the target slot/sub-slot in the case where the PUCCH resource is available. The terminal device further performs determination on subsequent slots/sub-slots in the case where the PUCCH resource is unavailable. ACK/NACK information includes deferred SPS ACK/NACK and non-deferred SPS ACK/NACK. Alternatively, ACK/NACK information includes ACK/NACK for dynamic scheduling and SPS ACK/NACK. Exemplarily, the ACK/NACK for dynamic scheduling includes ACK/NACK for a PDSCH that is scheduled via DCI transmitted by the network device, or ACK/NACK for DCI transmitted by the network device.

Exemplarily, the PUCCH resource may be specifically determined as follows.
The terminal device selects a PUCCH resource from resources preconfigured for transmission of SPS ACK/NACK in the case where all ACK/NACK information is SPS ACK/NACK. The resource for SPS ACK/NACK is configured through higher-layer signaling, for example, is a PUCCH resource configured through sps-PUCCH-AN-List-r16 or n1PUCCH-AN.
The terminal device uses a PUCCH resource indicated via DCI, in the case where all ACK/NACK information includes ACK/NACK for dynamic scheduling.

After the target slot/sub-slot is determined, transmission of the deferred SPS HARQ-ACK is not further deferred in the case where the deferred SPS HARQ-ACK is not transmitted in the target slot/sub-slot. Transmission of the deferred SPS HARQ-ACK is dropped due to no available PUCCH resource in the target slot/sub-slot and transmission of other high-priority information in the target slot/sub-slot.

Exemplarily, the terminal device further supports one-shot HARQ-ACK retransmission. Exemplarily, the terminal device receives DCI signaling, where the DCI is used for instructing the terminal device to retransmit an HARQ-ACK codebook, where the terminal device has been instructed to transmit the HARQ-ACK codebook. Referring to FIG. 3, the terminal device determines to transmit in slot n and on a PUCCH resource HARQ-ACK codebook 1, where HARQ-ACK codebook 1 is consisted of ACK/NACK bits. PUCCH 1 may be transmitted or may not be transmitted, where PUCCH 1 may not be transmitted due to transmission of other high-priority information. Exemplarily, the network device transmits DCI signaling to trigger the terminal device to retransmit in slot n+p HARQ-ACK codebook 1, where p is a positive integer. One DCI can only trigger retransmission of one HARQ-ACK codebook. Optionally, HARQ-ACK codebook 1 is transmitted through PUCCH 2.

In a scenario where the terminal device needs to transmit first feedback response information and second feedback response information to the network device, there is a problem on how to transmit in the same time unit both the first feedback response information and the second feedback response information in the case where deferral transmission of the first feedback response information is supported.

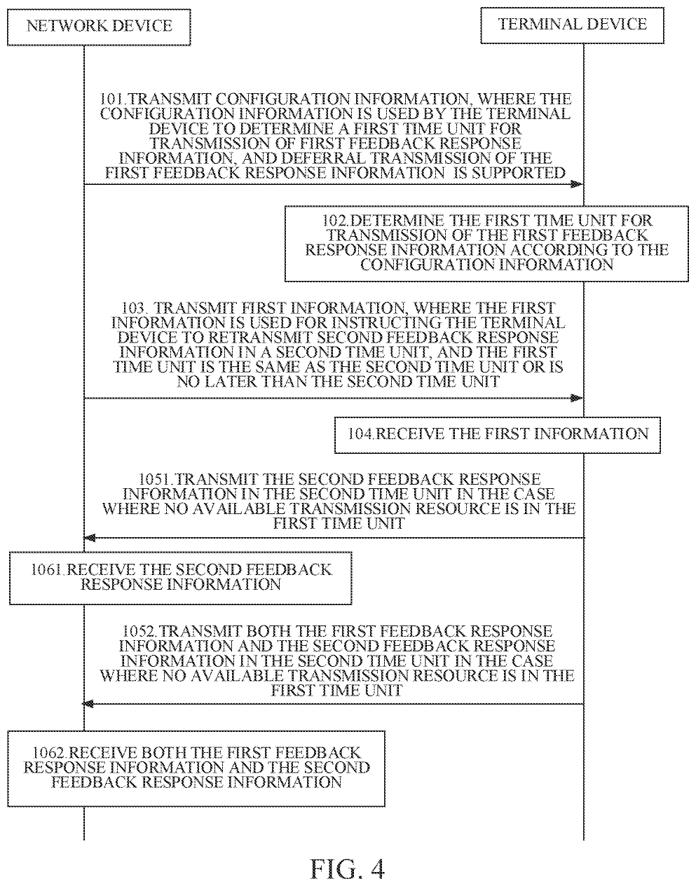

Exemplarily, referring to FIG. 4, a flow chart illustrating a method for information feedback is exemplarily provided in embodiments of the disclosure. The method is applied in the communication system illustrated in FIG. 1 and includes the following.

At 101, a network device transmits configuration information to a terminal device.

Exemplarily, the configuration information is used by the terminal device to determine a first time unit for transmission of first feedback response information. Deferral transmission of the first feedback response information is supported. Optionally, the configuration information is carried in an SPS PDSCH.

Feedback response information refers to information fed back by the terminal device to the network device after the terminal device receives downlink data transmitted by the network device. Feedback response information is also referred to as HARQ feedback information. Optionally, feedback response information includes ACK or NACK.

For example, the network device transmits a configuration for an SPS PDSCH to the terminal device, and the terminal device transmits in a preconfigured time unit feedback response information for the SPS PDSCH to the network device, where the feedback response information may be represented as SPS HARQ-ACK. For another example, in an HARQ mechanism, the feedback response information transmitted by the terminal device to the network device is an HARQ-ACK codebook.

Exemplarily, the first feedback response information is SPS HARQ-ACK. The preconfigured time unit is the first time unit.

In the case where no available transmission resource for the first feedback response information is in the first time unit, in order to avoid a reduction in system efficiency caused by dropping of the first feedback response information, it is supported to perform deferral transmission of the first feedback response information. Optionally, a time unit in which deferral transmission is to be performed may be configured by the network device.

The time unit may be determined according to a communication protocol or set according to a preset requirement.

For example, the time unit is a slot, a sub-slot, a mini-slot, or at least one time-domain symbol. A sub-slot or a mini-slot includes one or more time-domain symbols in a slot, and optionally, a slot includes at least one sub-slot or at least one mini-slot.

In embodiments of the disclosure, take that the time unit is a slot as an example.

At 102, the terminal device determines the first time unit for transmission of the first feedback response information according to the configuration information.

Take that the first feedback response information is SPS HARQ-ACK as an example. After the terminal device receives configuration for an SPS PDSCH, the terminal device determines, according to a parameter(s) in the configuration for the SPS PDSCH, the first time unit for transmission of the first feedback response information.

Optionally, after the terminal device determines the first time unit, the terminal device may determine whether there is an available transmission resource in the first time unit. In embodiments of the disclosure, no available transmission resource is in the first time unit.

For example, the network device transmits the configuration information to the terminal device. The configuration information is used by the terminal device to determine that the first time unit for transmission of the first feedback response information is slot n+2, where slot n+2 is a downlink slot. Since the downlink slot is used for downlink resource transmission, the terminal device determines that no available transmission resource for transmission of the first feedback response information is in slot n+2.

Optionally, the available transmission resource is a PUCCH resource available for transmission of feedback response information.

At 103, the network device transmits first information to the terminal device.

Exemplarily, the first information is used for instructing the terminal device to retransmit in a second time unit the second feedback response information. Optionally, the first information is carried in the DCI.

The first time unit is the second time unit, or the first time unit is no later than the second time unit. For relevant illustrations of the time unit, reference may be made to the foregoing illustrations, which may not be repeated herein.

Exemplarily, the second feedback response information is an HARQ-ACK codebook.

In the HARQ mechanism, other high-priority services of other terminal devices or the terminal device may occupy resources due to multiplexing and too short processing time, which may result in that the terminal device does not actually transmit the HARQ-ACK codebook. Alternatively, the terminal device transmits the HARQ-ACK codebook, but loss or garbled codes may occur to the HARQ-ACK codebook due to poor channel quality, which may result in that the network device fails to successfully receive the HARQ-ACK codebook. In these cases, the terminal device needs to retransmit the HARQ-ACK codebook.

According to transmission requirements, two types of feedback response information each may have a priority. Exemplarily, both the first feedback response information and the second feedback response information may be configured with a priority or may not be configured with a priority.

Optionally, a priority of the first feedback response information is the same as a priority of the second feedback response information, or the terminal device supports multiplexing transmission of uplink control information (UCI) with different priorities.

Both the first feedback response information and the second feedback response information are a type of UCI.

Take that the first feedback response information is SPS HARQ-ACK and the second feedback response information is an HARQ-ACK codebook as an example. A priority of the SPS HARQ-ACK is the same as a priority of the HARQ-ACK codebook. Alternatively, the priority of the SPS HARQ-ACK is different from that of the HARQ-ACK codebook, and the terminal device supports multiplexing transmission of UCI with different priorities.

Exemplarily, the terminal device does not expect that the priority of the second feedback response information is lower than the priority of the first feedback response information.

At 104, the terminal device receives the first information.

After the terminal device receives the first information, the terminal device can determine the second time unit.

Take that the time unit is a slot as an example. The first time unit is a slot determined according to the configuration information, and the second time unit is a slot determined according to the first information. The first time unit is no later than the second time unit. For example, both the first time unit and the second time unit are slot n+5. For another example, the first time unit is slot n+2, and the second time unit is slot n+5.

After the terminal device determines the second time unit, the terminal device may select to transmit the second feedback response information in the second time unit, and in this case, the terminal device performs an operation at 1051 and an operation at 1061. Since deferral transmission of the first feedback response information is supported, the terminal device may further select to transmit both the first feedback response information and the second feedback response information in the second time unit, and in this case, the terminal device performs an operation at 1052 and an operation at 1062.

For example, merely the operation at 1051 or merely the operation at 1052 is performed, and the operation at 1051 and the operation at 1052 cannot be both performed.

At 1051, the terminal device transmits in the second time unit the second feedback response information in the case where no available transmission resource is in the first time unit.

In the case where no available transmission resource is in the first time unit and the first information instructs the terminal device to retransmit in the second time unit the second feedback response information, the terminal device determines the second time unit, and transmits on an available transmission resource the second feedback response information in the second time unit. Optionally, the available transmission resource is a PUCCH resource available for transmission of feedback response information.

It may be noted that the terminal device transmitting in the second time unit the second feedback response information may mean that the terminal device transmits in the second time unit the second feedback response information and does not transmit in the second time unit the first feedback response information.

At 1061, the network device receives in the second time unit the second feedback response information.

Take that the second feedback response information is an HARQ-ACK codebook as an example.

The terminal device determines that the second time unit is slot n+5 according to the first information and then retransmits in slot n+5 the HARQ-ACK codebook on the PUCCH resource. The network device receives the HARQ-ACK codebook in slot n+5.

At 1052, the terminal device transmits in the second time unit both the first feedback response information and the second feedback response information in the case where no available transmission resource is in the first time unit.

In the case where no available transmission resource is in the first time unit and the first information instructs the terminal device to retransmit in the second time unit the second feedback response information, the terminal device determines the second time unit, and transmits on an available transmission resource both the first feedback response information and the second feedback response information in the second time unit. Optionally, the available transmission resource is a PUCCH resource available for transmission of feedback response information.

Exemplarily, the terminal device concatenates the first feedback response information and the second feedback response information and then transmits the first feedback response information and the second feedback response information that are concatenated. For example, the terminal device concatenates the first feedback response information and the second feedback response information, and then transmits, in the second time unit and on the same transmission resource, the first feedback response information and the second feedback response information that are concatenated.

The terminal device may transmit both the first feedback response information and the second feedback response information in the second time unit in the case where the first time unit is the second time unit.

Since deferral transmission of the first feedback response information is supported, the terminal device may defer transmission of the first feedback response information to be performed in the second time unit in the case where the first time unit is no later than the second time unit. Subsequently, after the terminal device determines the second time unit according to the first information, the terminal device transmits on the available transmission resource both the first feedback response information and the second feedback response information in the second time unit.

Optionally, the available transmission resource is a PUCCH resource available for transmission of feedback response information.

At 1062, the network device receives in the second time unit both the first feedback response information and the second feedback response information.

Take that the first feedback response information is SPS HARQ-ACK and the second feedback response information is an HARQ-ACK codebook as an example. The terminal device determines that the first time unit for transmission of the first feedback response information is slot n+2 according to the configuration information. Since slot n+2 is a downlink slot, the terminal device determines that no available PUCCH resource is in slot n+2. After the terminal device receives the first information, the terminal device determines that the second time unit is slot n+5.

The terminal device may defer transmission of the SPS HARQ-ACK to be performed in slot n+5 since deferral transmission of the first feedback response information is supported. Subsequently, the terminal device transmits, in slot n+5 and on the PUCCH resource, the SPS HARQ-ACK and HARQ-ACK codebook that are concatenated. The network device receives both the SPS HARQ-ACK and the HARQ-ACK codebook in slot n+5.

Optionally, since deferral transmission of the first feedback response information is supported, whether deferral transmission of the first feedback response information is performed or not may be determined according to a relationship between a time unit in which deferral transmission of the first feedback response is to be performed and a maximum feedback deferral position corresponding to the first feedback response information.

The maximum feedback deferral position corresponding to the first feedback response information is a certain time unit later than the first time unit, where in the time unit there is an available transmission resource for transmission of the first feedback response information. The first time unit is determined according to the configuration information and used for transmission of the first feedback response information.

Optionally, the maximum feedback deferral position corresponding to the first feedback response information may be preconfigured by the network device. For example, the network device configures higher-layer signaling or activation signaling for the terminal device, where the signaling indicates a maximum feedback deferral corresponding to the first feedback response information.

Take that the time unit is a slot as an example. The network device transmits the configuration information to the terminal device, and the terminal device determines that the first time unit is slot n+k1, where k1 is determined according to the configuration information. Since no available transmission resource for the first feedback response information is in slot n+k1, transmission of the first feedback response information may be deferred to be performed in slot n+k1+kdefer. A maximum deferral value in terms of k1+kdefer is the maximum feedback deferral.

Take that the time unit for deferral transmission is the second time unit as an example. Optionally, the second time unit is the maximum feedback deferral position corresponding to the first feedback response information, or the second time unit is no later than the maximum feedback deferral position corresponding to the first feedback response information.

For example, in the case where the first time unit is slot n+2 and the maximum feedback deferral corresponding to the first feedback response information is 2, the second time unit is slot n+2 and is the maximum feedback deferral position corresponding to the first feedback response information. Alternatively, in the case where the maximum feedback deferral corresponding to the first feedback response information is 1, the second time unit is a slot no later than slot n+2 and is no later than the maximum feedback deferral position corresponding to the first feedback response information.

Exemplarily, the terminal device determines to transmit the first feedback response information in slot n+k1 according to the configuration information. The terminal device does not expect to receive signaling, where the signaling is used to trigger the terminal device to transmit the second feedback response information in slot m. k1 is determined according to the configuration information, and k1≤m≤the maximum feedback deferral corresponding to the first feedback response information.

For example, the terminal device determines to transmit the first feedback response information in slot n+2 according to the configuration information, and the maximum feedback deferral corresponding to the first feedback response information is 5. In this case, the terminal device does not expect to receive signaling, where the signaling is used to trigger the terminal device to transmit the second feedback response information in slot n+4.

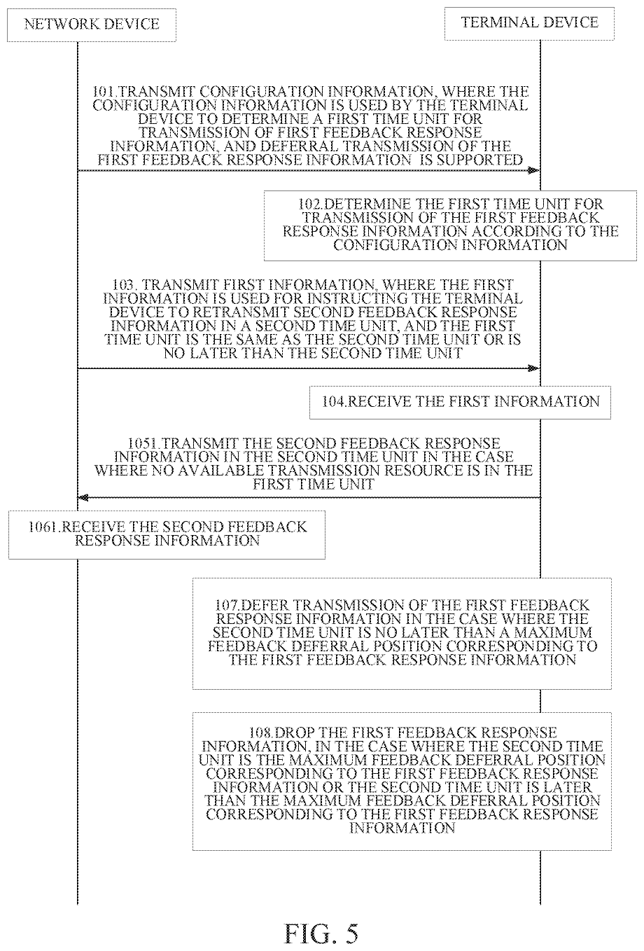

Optionally, the terminal device may perform different operations according to determination results of the relationship between the second time unit and the maximum feedback deferral position corresponding to the first feedback response information. Referring to FIG. 5, on the premise of performing the operation at 1051 and the operation at 1061, the method provided in embodiments of the disclosure further includes an operation at 107 and an operation at 108.

The operation at 107 is performed in the case where the second time unit is no later than the maximum feedback deferral position corresponding to the first feedback response information. The operation at 108 is performed, in the case where the second time unit is the maximum feedback deferral position corresponding to the first feedback response information or the second time unit is later than the maximum feedback deferral position corresponding to the first feedback response information. Exemplarily, merely the operation at 107 or merely the operation at 108 is performed and the operation at 107 and the operation at 108 cannot be both performed.

At 107, the terminal device defers transmission of the first feedback response information in the case where the second time unit is no later than the maximum feedback deferral position corresponding to the first feedback response information.

Exemplarily, deferral transmission of the first feedback response information means that in the case where there is an available time unit for transmission of the first feedback response information between the second time unit and the maximum feedback deferral position corresponding to the first feedback response information, the first feedback response information is to be transmitted in the available time unit.

For example, the first time unit is slot n+2, the second time unit is slot n+5, and the maximum feedback deferral position corresponding to the first feedback response information is slot n+8. In the case where slot n+7 between slot n+5 and slot n+8 is available for transmission of the first feedback response information, the terminal device may defer transmission of the first feedback response information to be performed in slot n+7.

At 108, the terminal device drops the first feedback response information, in the case where the second time unit is the maximum feedback deferral position corresponding to the first feedback response information or the second time unit is later than the maximum feedback deferral position corresponding to the first feedback response information.

Take that the time unit is a slot and the maximum feedback deferral corresponding to the first feedback response information is the maximum deferral value in terms of k1+kdefer as an example. For example, in the case where k1 is determined to be 2 according to the configuration information, the first time unit is slot n+2, and the second time unit determined according to the first information is slot n+5. Assuming that slot n+2, slot n+3, and slot n+4 all are downlink slots, transmission of the first feedback response information continues to be deferred.

In slot n+5, the terminal device determines a relationship between slot n+5 and the maximum feedback deferral position.

Assuming that the maximum deferral value in terms of k1+kdefer is 8, slot n+5 is no later than the maximum feedback deferral position (namely, a position where slot n+8 is located), and in this case, the terminal device performs the operation at 107, that is, continues to defer transmission of the first feedback response information. Assuming that the maximum deferral value in terms of k1+kdefer is 5, slot n+5 is the maximum feedback deferral position (namely, a position where slot n+5 is located), and in this case, the terminal device performs the operation at 108, that is, drops the first feedback response information. Assuming that the maximum deferral value in terms of k1+kdefer is 3, slot n+5 is later than the maximum feedback deferral position (namely, a position where slot n+3 is located), the terminal device performs the operation at 108, that is, drops the first feedback response information.

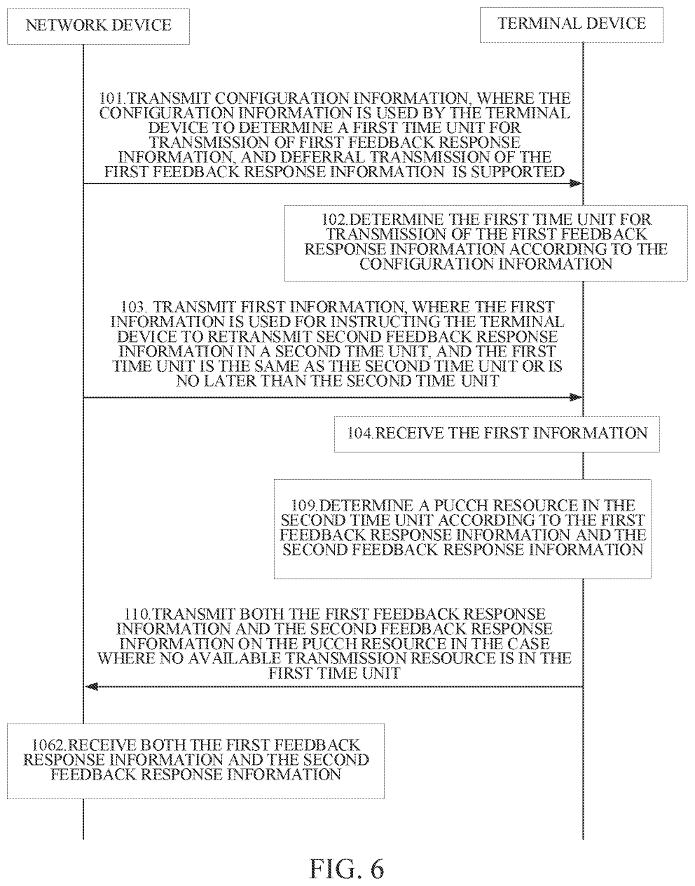

Optionally, in embodiments of the disclosure, an optional transmission mode is provided for transmission of both the first feedback response information and the second feedback response information in the second time unit. Referring to FIG. 6, in the method provided in embodiments of the disclosure, the operation at 1052 may be implemented as an operation at 109 and an operation at 110.

At 109, determine a PUCCH resource in the second time unit according to the first feedback response information and the second feedback response information.

After the terminal device obtains both the first feedback response information and the second feedback response information that need to be transmitted, the terminal device may transmit in the second time unit both the first feedback response information and the second feedback response information. In order to realize transmission, the terminal device needs to determine an available transmission resource, where the transmission resource is a PUCCH resource.

At 110, transmit on the PUCCH resource both the first feedback response information and the second feedback response information in the case where no available transmission resource is in the first time unit.

After the terminal device determines the PUCCH resource, the terminal device transmits both the first feedback response information and the second feedback response information on the PUCCH resource. Exemplarily, the terminal device concatenates the first feedback response information and the second feedback response information and then transmits on the determined PUCCH resource the first feedback response information and the second feedback response information that are concatenated.

Optionally, take that the first feedback response information is SPS HARQ-ACK and the second feedback response information is an HARQ-ACK codebook as an example. In this case, the PUCCH resource is determined according to the SPS HARQ-ACK and HARQ-ACK information bits in the HARQ-ACK codebook.

Exemplarily, the terminal device determines a target set from at least one preconfigured PUCCH resource set according to the total number of HARQ-ACK information bits, where the target set contains at least one candidate PUCCH resource. Subsequently, the terminal device determines a PUCCH resource according to signaling. For example, the terminal device determines a required PUCCH resource from the determined target set according to an indication of a PUCCH resource indicator (PRI) field in DCI.

Exemplarily, the terminal device does not expect that the PUCCH resource is unavailable.

Optionally, the terminal device may further perform the operation at 1051 and the operation at 1061 in the case where the PUCCH resource is unavailable.

The terminal device determines whether the PUCCH resource is available after the terminal device determines the PUCCH resource according to the first feedback response information and the second feedback response information. The terminal device may transmit the second feedback response information in the second time unit in the case where the PUCCH resource is unavailable. Optionally, in the case where the terminal device transmits the second feedback response information in the second time unit, the terminal device may further perform the operation at 107 or the operation at 108, to implement deferral transmission of the first feedback response information or dropping of the first feedback response information.

Exemplarily, in embodiments of the disclosure, the operations performed by the terminal device side may be an embodiment of the method for information feedback applied in the terminal device, and the operations performed by the network device side may be an embodiment of the method for information feedback applied in the network device. For specific illustrations of operations of the method for information feedback, reference may be made to the foregoing content, which may not be repeated herein.

In conclusion, in the method provided in embodiments of the disclosure, an implementation manner in which the two types of feedback response information may be transmitted in the same time unit is provided. Specifically, the terminal device transmits the second feedback response information in the second time unit or transmits both the first feedback response information and the second feedback response information in the second time unit, in the case where deferral transmission of the first feedback response information is supported.

Optionally, in the case where the terminal device determines to transmit the second feedback response information in the second time unit, the terminal device determines, according to the relationship between the second time unit and the maximum feedback deferral position corresponding to the first feedback response information, to defer transmission of the first feedback response information or drop the first feedback response information, thereby simplifying the processing of the terminal device on the premise of ensuring that the transmission of the second feedback response information is not affected. Optionally, transmission of the first feedback response information may be deferred in the case where the maximum feedback deferral corresponding to the first feedback response information is greater than a preset threshold, thereby avoiding dropping of the first feedback response information. The preset threshold may be configured by the network device and may be relatively large.

Optionally, after the terminal device determines the PUCCH resource according to the first feedback response information and the second feedback response information, the terminal device transmits in the second time unit both the first feedback response information and the second feedback response information in the case where the PUCCH resource is available, thereby avoiding unreasonable scheduling of the network device and ensuring information transmission. The first feedback response information and the second feedback response information may be transmitted in different time units through coordination scheduling of the network device in the case where the PUCCH resource is unavailable.

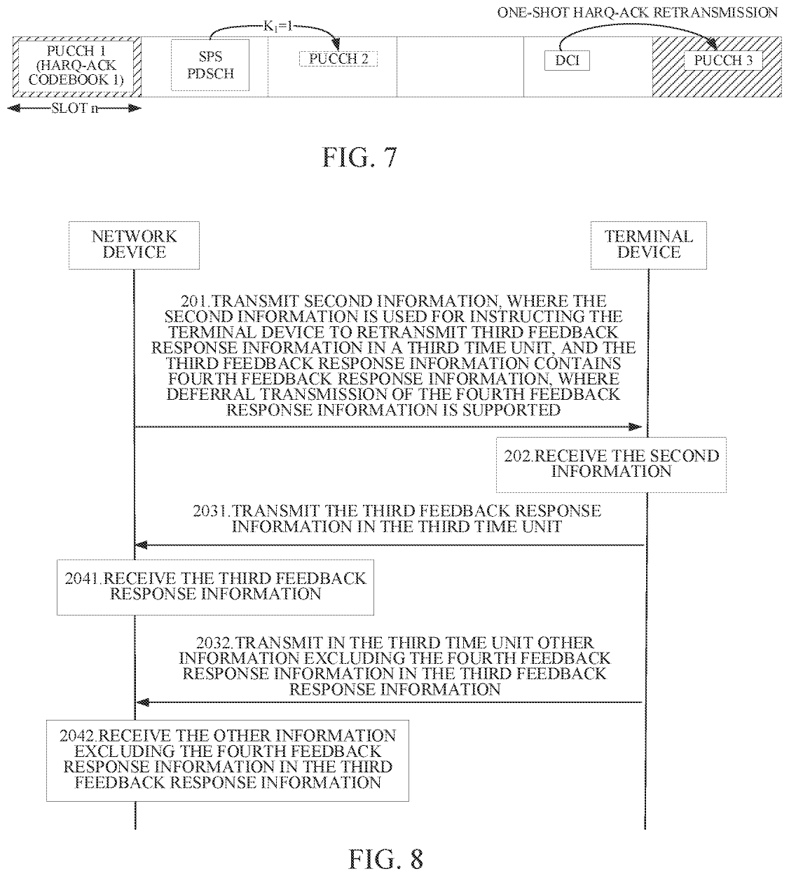

Exemplarily, in embodiments of the disclosure, FIG. 7 is taken as an example to illustrate the method for information feedback provided in the foregoing embodiments.

Referring to FIG. 7, take that the time unit is a slot, the first feedback response information is SPS HARQ-ACK, and the second feedback response information is HARQ-ACK codebook 1 as an example, where a shaded part represents an uplink slot, and a blank part represents a downlink slot. It may be seen that slot n and slot n+5 are uplink slots, and the remaining slots are downlink slots.

The terminal device determines to transmit HARQ-ACK codebook 1 in slot n.

The terminal device receives in slot n+1 SPS PDSCH configuration information transmitted by the network device, where the configuration information is used by the terminal device to determine that the first time unit for transmission of SPS HARQ-ACK is slot n+2. Slot n+2 is a downlink slot, and accordingly the SPS HARQ-ACK cannot be transmitted in slot n+2, and thus transmission of the SPS HARQ-ACK needs to be deferred.

The terminal device receives in slot n+4 DCI transmitted by the network device, where the DCI is used to trigger the terminal device to retransmit HARQ-ACK codebook 1 in slot n+5.

According to the DCI and the SPS PDSCH configuration information, the terminal device may perform information transmission in slot n+5 in one of the following manners.

Manner 1: the terminal device transmits HARQ-ACK codebook 1 in slot n+5.

Exemplarily, a priority of HARQ-ACK codebook 1 is not lower than a priority of SPS HARQ-ACK, or HARQ-ACK codebook 1 is configured with no priority.

In this case, the terminal device may determine a relationship between slot n+5 and the maximum feedback deferral position corresponding to the SPS HARQ-ACK. The terminal device continues to defer transmission of the SPS HARQ-ACK in the case where slot n+5 is no later than the maximum feedback deferral position. The terminal device drops the SPS HARQ-ACK in the case where slot n+5 is later than the maximum feedback deferral position.

Optionally, the terminal device does not expect that the priority of HARQ-ACK codebook 1 is lower than the priority of the SPS HARQ-ACK. Transmission of HARQ-ACK codebook 1 may be configured by the network device. Optionally, the network device configures transmission of HARQ-ACK codebook 1 via DCI.

HARQ-ACK codebook 1 and the SPS HARQ-ACK may be transmitted in different slots through coordination scheduling of the network device in the case where the priority of HARQ-ACK codebook 1 is lower than the priority of the SPS HARQ-ACK.

Optionally, the terminal device determines a first PUCCH resource according to the SPS HARQ-ACK in the case where the priority of HARQ-ACK codebook 1 is lower than the priority of the SPS HARQ-ACK.

The terminal device transmits the SPS HARQ-ACK on the first PUCCH resource in the case where the first PUCCH resource is available. Optionally, in the case where a second PUCCH resource for transmission of HARQ-ACK codebook 1 does not overlap the first PUCCH resource, the terminal device may transmit HARQ-ACK codebook 1 on the second PUCCH resource.

The terminal device transmits HARQ-ACK codebook 1 in slot n+5 in the case where the first PUCCH resource is unavailable. The terminal device continues to defer transmission of the SPS HARQ-ACK in the case where slot n+5 is no later than a maximum feedback deferral position corresponding to the SPS HARQ-ACK. Otherwise, the terminal device drops the SPS HARQ-ACK.

Manner 2: the terminal device transmits in slot n+5 both HARQ-ACK codebook 1 and SPS HARQ-ACK.

Exemplarily, the priority of HARQ-ACK codebook 1 is the same as the priority of the SPS HARQ-ACK. Alternatively, HARQ-ACK codebook 1 is configured with no priority. Alternatively, the terminal device supports multiplexing transmission of UCI with different priorities.

In slot n+5, the terminal device needs to determine an available transmission resource for transmission of both HARQ-ACK codebook 1 and the SPS HARQ-ACK.

Optionally, the available transmission resource may be determined by the terminal device according to the SPS HARQ-ACK and HARQ-ACK information bits in HARQ-ACK codebook 1. Exemplarily, the terminal device determines a target set from at least one preconfigured PUCCH resource set according to the total number of HARQ-ACK information bits, where the target set contains at least one PUCCH resource. Subsequently, the terminal device determines a required PUCCH resource from the determined target set according to an indication of a PRI field in DCI.

Exemplarily, the terminal device does not expect that the PUCCH resource determined according to the DCI is unavailable.

The terminal device transmits both HARQ-ACK codebook 1 and the SPS HARQ-ACK in slot n+5 in the case where the determined PUCCH resource is available.

The terminal device transmits HARQ-ACK codebook 1 in slot n+5 in the case where the determined PUCCH resource is unavailable. Subsequently, the terminal device may determine a relationship between slot n+5 and the maximum feedback deferral position corresponding to the SPS HARQ-ACK. The terminal device continues to defer transmission of the SPS HARQ-ACK in the case where slot n+5 is no later than the maximum feedback deferral position. The terminal device drops the SPS HARQ-ACK in the case where slot n+5 is later than the maximum feedback deferral position.

Manner 3: the terminal device does not support to be configured to simultaneously perform deferral transmission of SPS HARQ-ACK and retransmission of HARQ-ACK codebook 1.

The terminal device can be enabled to perform deferral transmission of the SPS HARQ-ACK and retransmission of HARQ-ACK codebook 1 in different slots according to scheduling of the network device, thereby avoiding a complex scenario and simplifying the processing of the terminal device.

Optionally, the terminal device does not expect to receive DCI, in the case where the terminal device receives configuration information for an SPS PDSCH in slot n+1 and no available transmission resource for HARQ-ACK information for the SPS PDSCH is in slot n+2. The DCI is used to trigger the terminal device to retransmit HARQ-ACK codebook 1 in slot m, and k1≤m≤maximum deferral corresponding to the SPS HARQ-ACK.

Exemplarily, in embodiments of the disclosure, the operations performed by the terminal device side may be an embodiment of the method for information feedback applied in the terminal device, and the operations performed by the network device side may be an embodiment of the method for information feedback applied in the network device. For specific illustrations of operations of the method for information feedback, reference may be made to the foregoing content, which may not be repeated herein.

In conclusion, the method for information feedback provided in the above embodiment is illustrated in this embodiment of the disclosure. According to the transmission process illustrated in FIG. 7, the terminal device may perform transmission in slot n+5 in three optional transmission modes as follows. The terminal device transmits HARQ-ACK codebook 1 in slot n+5. The terminal device transmits both HARQ-ACK codebook 1 and SPS HARQ-ACK in slot n+5. Alternatively, the terminal device does not support to be configured to simultaneously perform deferral transmission of SPS HARQ-ACK and retransmission of HARQ-ACK codebook 1.

In a scenario where third feedback response information transmitted by the terminal device to the network device contains fourth feedback response information, there exists a problem on how to transmit in a third time unit the third feedback response information in the case where deferral transmission of the fourth feedback response information is supported.

Exemplarily, referring to FIG. 8, a flow chart illustrating a method for information feedback is exemplarily provided in embodiments of the disclosure. The method is applied in the communication system illustrated in FIG. 1 and includes the following.

At 201, a network device transmits second information to a terminal device.

Exemplarily, the second information is used for instructing the terminal device to retransmit in a third time unit third feedback response information, and the third feedback response information contains fourth feedback response information, where deferral transmission of the fourth feedback response information is supported. Optionally, the second information is carried in DCI.

At 202, the terminal device receives the second information.

After the terminal device receives the second information transmitted by the network device, the terminal device can determine the third time unit and obtain the third feedback response information.

Exemplarily, in embodiments of the disclosure, take that the time unit is a slot as an example.

After the terminal device determines the third time unit, there are two choices according to different transmission information. The terminal device selects to transmit in the third time unit all information in the third feedback response information, and in this case, the terminal device performs an operation at 2031 and an operation at 2041. The terminal device selects to transmit in the third time unit partial information in first feedback response information, and in this case, the terminal device performs an operation at 2032 and an operation at 2042.

Exemplarily, merely the operation at 2031 or merely the operation at 2032 is performed and the operation at 2031 and the operation at 2032 cannot be both performed.

At 2031, the terminal device transmits in the third time unit the third feedback response information.

After the terminal device determines the third time unit, the terminal device transmits, in the third time unit and on an available transmission resource, all the information in the third feedback response information. Optionally, the available transmission resource is a PUCCH resource available for transmission of feedback response information.

At 2041, the network device receives in the third time unit the third feedback response information.

Exemplarily, the third feedback response information is a retransmitted HARQ-ACK codebook, and the HARQ-ACK codebook includes non-deferred HARQ-ACK codebook bits and deferred HARQ-ACK codebook bits.

In the case where the terminal device determines that the third time unit is slot n+5 according to the first information, the terminal device retransmits in slot n+5 the HARQ-ACK codebook on the PUCCH resource, and the network device receives both the non-deferred HARQ-ACK codebook bits and the deferred HARQ-ACK codebook bits in slot n+5.

Optionally, since deferral transmission of the fourth feedback response information is supported, a maximum feedback deferral position corresponding to the fourth feedback response information is required to be later than the third time unit in the case where the terminal device expects to transmit in the third time unit the third feedback response information containing the fourth feedback response information. The maximum feedback deferral position corresponding to the fourth feedback response information is similar to the maximum feedback deferral position corresponding to the first feedback response information, and relevant explanations may be used as reference, which may not be repeated herein.

At 2032, the terminal device transmits in the third time unit other information excluding the fourth feedback response information in the third feedback response information.

After the terminal device determines the third time unit, the terminal device transmits, in the third time unit and on the available transmission resource, partial information in the third feedback response information. Optionally, the available transmission resource is a PUCCH resource available for transmission of feedback response information.

At 2042, the network device receives in the third time unit the other information excluding the fourth feedback response information in the third feedback response information.

Partial information in the third feedback response information transmitted by the terminal device varies according to a variation of the fourth feedback information. Exemplarily, two optional implementation manners for the fourth feedback response information are provided in embodiments of the disclosure.

Implementation manner 1: the third feedback response information contains non-deferred feedback response information (e.g., non-deferred HARQ-ACK) and deferred feedback response information (e.g., deferred HARQ-ACK), and the fourth feedback response information is the deferred feedback response information.

It may be noted that “non-deferred” and “deferred” herein are defined relative to the third time unit.

Take that the non-deferred feedback response information is an HARQ-ACK codebook and the deferred feedback response information is SPS HARQ-ACK as an example. For example, in the case where the HARQ-ACK codebook is configured to be transmitted in slot n+5, the third time unit is slot n+5.

Optionally, the terminal device defers transmission of the SPS HARQ-ACK to be performed in slot n+5 in the case where the SPS HARQ-ACK is configured to be transmitted in slot n+2 and there is no available physical resource in slot n+2. In this case, transmission of the SPS HARQ-ACK is deferred relative to slot n+5.

In the case where the third feedback response information contains both the non-deferred feedback response information and the deferred feedback response information and the fourth feedback response information is the deferred feedback response information, the terminal device drops in the third time unit the fourth feedback response information, and thus the third feedback response information transmitted by the terminal device contains the non-deferred feedback response information.

Implementation manner 2: the fourth feedback response information is feedback response information a maximum feedback deferral position corresponding to which is no later than the third time unit.

According to a relationship between the third time unit and the maximum feedback deferral position corresponding to the feedback response information, the feedback response information may be classified into two types as follows. A maximum feedback deferral position corresponding to a first type of feedback response information is no later than the third time unit, and the first type of feedback response information may be regarded as expired feedback response information. A maximum feedback deferral position corresponding to a second type of feedback response information is the third time unit or later than the third time unit, and the second type of feedback response information may be regarded as unexpired feedback response information.

Exemplarily, the fourth feedback response information is the expired feedback response information.

The terminal device needs to remove the fourth feedback response information in the case where the fourth feedback response information is the feedback response information maximum feedback deferral position corresponding to which is no later than the third time unit, that is, the terminal device removes the expired feedback response information. Subsequently, the terminal device transmits in the third time unit partial information in the third feedback response information. At this point, the third feedback response information transmitted by the terminal device in the third time unit contains the unexpired feedback response information.

Exemplarily, take that the third feedback response information is a retransmitted HARQ-ACK codebook as an example. In this case, the third feedback response information contains non-deferred HARQ-ACK codebook bits and deferred HARQ-ACK codebook bits, where deferral transmission of the deferred HARQ-ACK codebook bits is supported.

The fourth feedback response information is partial information in the deferred HARQ-ACK codebook bits. Assuming that the deferred HARQ-ACK codebook bits contain 10-bit information, 6-bit information in the 10-bit information is expired feedback response information, and 4-bit information in the 10-bit information is unexpired feedback response information, the fourth feedback response information is the 6-bit expired feedback response information.

The terminal device drops in the third time unit the 6-bit expired feedback response information in the case where the fourth feedback response information is the feedback response information the maximum feedback deferral position corresponding to which is no later than the third time unit. The third feedback response information transmitted by the terminal device contains the non-deferred HARQ-ACK codebook bits and the 4-bit unexpired feedback response information.

Exemplarily, referring to FIG. 9, the method provided in embodiments of the disclosure is illustrated by taking that the time unit is a slot and the third feedback response information is retransmitted HARQ-ACK codebook 1 as an example, where a shaded part represents an uplink slot, and a blank part represents a downlink slot. It may be seen that slot n+3 and slot n+5 are uplink slots, and the remaining slots are downlink slots.

The terminal device receives in slot n SPS PDSCH configuration information transmitted by the network device, and determines that the first time unit for transmission of the SPS HARQ-ACK is slot n+1 according to the configuration information. Slot n+1 is a downlink slot, and accordingly the SPS HARQ-ACK cannot be transmitted in slot n+1, and thus transmission of the SPS HARQ-ACK needs to be deferred.

The terminal device receives in slot n+4 DCI transmitted by the network device, where the DCI is used to trigger the terminal device to retransmit HARQ-ACK codebook 1 in slot n+5.

Exemplarily, the third feedback response information is retransmitted HARQ-ACK codebook 1, where HARQ-ACK codebook 1 contains non-deferred HARQ-ACK codebook bits and deferred HARQ-ACK codebook bits.

According to the DCI and the SPS PDSCH configuration information, the terminal device may perform information transmission in slot n+5 in one of the following manners.

Manner 1: the terminal device retransmits the non-deferred HARQ-ACK codebook bits in slot n+5.

Optionally, the fourth feedback response information is deferred HARQ-ACK codebook bits.

In slot n+5, the terminal device drops the deferred HARQ-ACK codebook bits and retransmits merely the non-deferred HARQ-ACK codebook bits, thereby avoiding a complex scenario and simplifying the processing of the terminal device.

Manner 2: the terminal device retransmits in slot n+5 other HARQ-ACK information excluding bit information a maximum feedback deferral position corresponding to which is no later than slot n+5 in HARQ-ACK codebook 1.

Optionally, the fourth feedback response information is partial information in the deferred HARQ-ACK codebook bits, where a maximum feedback deferral position corresponding to the partial information is no later than slot n+5.

Assuming that the deferred HARQ-ACK codebook bits contain 10-bit information, 6-bit information in the 10-bit information is expired feedback response information, and 4-bit information in the 10-bit information is unexpired feedback response information, the fourth feedback response information is the 6-bit expired feedback response information, and the unexpired feedback response information is not in the fourth feedback response information.

The terminal device drops in the third time unit the 6-bit expired feedback response information in the case where the fourth feedback response information is feedback response information a maximum feedback deferral position corresponding to which is no later than the third time unit. The third feedback response information transmitted by the terminal device contains the non-deferred HARQ-ACK codebook bits and the 4-bit unexpired feedback response information.

Manner 3: the terminal device retransmits in slot n+5 both the non-deferred HARQ-ACK codebook bits and the deferred HARQ-ACK codebook bits.

Exemplarily, in embodiments of the disclosure, the operations performed by the terminal device side may be an embodiment of the method for information feedback applied in the terminal device, and the operations performed by the network device side may be an embodiment of the method for information feedback applied in the network device. For specific illustrations of operations of the method for information feedback, reference may be made to the foregoing content, which may not be repeated herein.

In conclusion, in the method provided in embodiments of the disclosure, an implementation manner is provided in the case where the third feedback response information contains the fourth feedback response information and deferral transmission of the fourth feedback response information is supported. The terminal device transmits in the third time unit all information in the third feedback response information or partial information in the third feedback response information.

Optionally, the terminal device transmits in the third time unit all information in the third feedback response information, thereby simplifying implementation of the terminal device. Alternatively, the terminal device transmits in the third time unit other information excluding the fourth feedback response information in the third feedback response information, and drops information a maximum feedback deferral position corresponding to which is no later than the third time unit, thereby improving transmission efficiency.

There is a problem on a conflict between initial transmission of feedback response information and retransmission of feedback response information. Initial transmission of the first feedback response information may be performed in a time unit determined according to configuration information, or may be performed in a time unit in which deferral transmission of the first feedback response information is determined to be performed, which is not limited in the disclosure. Optionally, deferral transmission of the first feedback response information is supported.

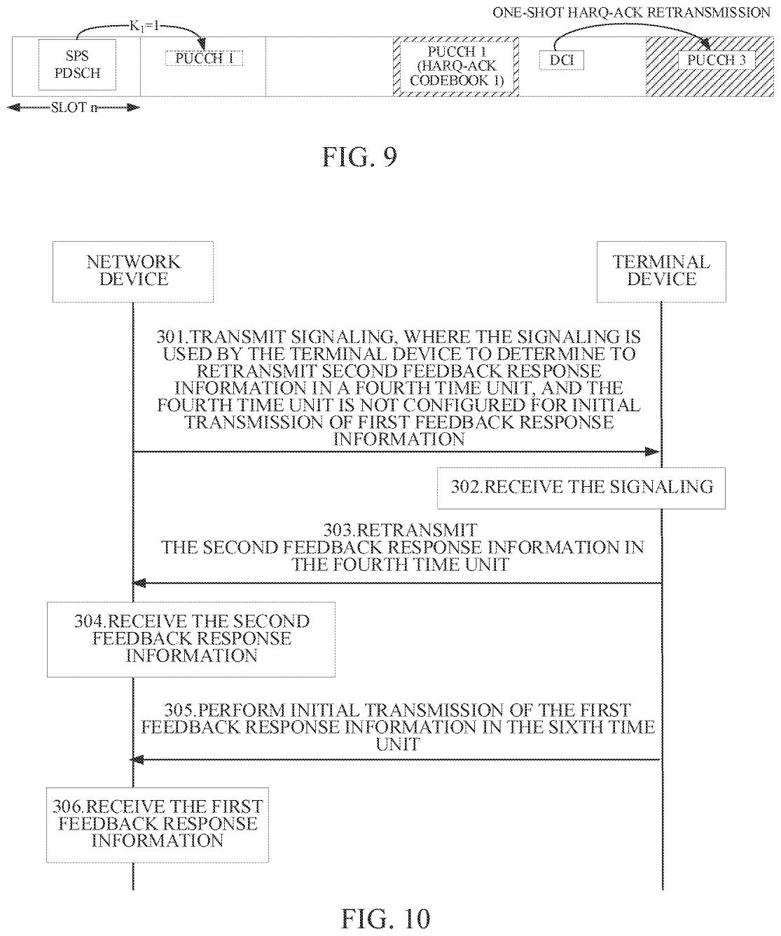

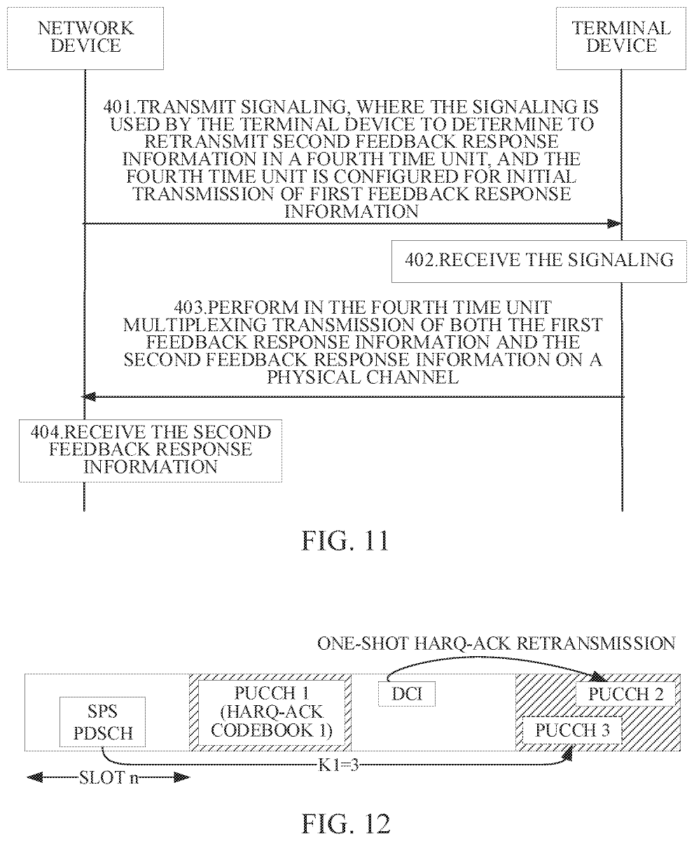

Two optional technical solutions are provided in embodiments of the disclosure for initial transmission of the first feedback response information and retransmission of the second feedback response information. Referring to FIG. 10, the terminal device does not expect to be configured to perform in the same time unit both initial transmission of the first feedback response information and retransmission of the second feedback response information. Alternatively, referring to FIG. 11, the terminal device supports performing of initial transmission of the first feedback response information and retransmission of the second feedback response information in the same time unit.

Exemplarily, referring to FIG. 10, a flow chart illustrating a method for information feedback is further provided in embodiments of the disclosure. The method is applied in the communication system illustrated in FIG. 1, and the conflict between initial transmission of feedback response information and retransmission of feedback response information may be avoided with the method. The method includes the following.

At 301, a network device transmits signaling to a terminal device.

Exemplarily, the signaling is used by the terminal device to determine to retransmit in a fourth time unit second feedback response information. The fourth time unit is not configured for initial transmission of first feedback response information. Optionally, the signaling is carried in DCI.

Configuration signaling for the first feedback response information is separate from configuration signaling for the second feedback response information. Exemplarily, the signaling includes multiple separate configuration signaling respectively for configuring initial transmission of the first feedback response information and retransmission of the second feedback response information.

Optionally, the second feedback response information is initially transmitted in a fifth time unit, and the fifth time unit is no later than the fourth time unit.

Take that the second feedback response information is an HARQ-ACK codebook as an example. The terminal device initially transmits in slot n+1 the HARQ-ACK codebook. The terminal device receives in slot n+2 DCI transmitted by the network device, where the DCI is used for instructing the terminal device to retransmit in slot n+3 a second HARQ-ACK codebook. The fourth time unit is slot n+3, and the fifth time unit is slot n+1.

Optionally, the terminal device initially transmits in a sixth time unit the first feedback response information, where the sixth time unit is different from the fourth time unit. An order of the sixth time unit and the fourth time unit is not limited. For example, the terminal device retransmits the second feedback response information in slot n+3, and initially transmits the first feedback response information in any one slot except slot n+3.

At 302, the terminal device receives the signaling.

Exemplarily, for relevant illustrations of the first feedback response information, the second feedback response information, and the time unit, reference may be made to the foregoing illustration, which is not repeated herein.

Optionally, a priority of the first feedback response information is the same as a priority of the second feedback response information. Alternatively, the terminal device supports multiplexing transmission of UCI with different priorities, and the priority of the first feedback response information is different from the priority of the second feedback response information.

The terminal device transmits feedback response information with a relatively high priority, in the case where the priority of the first feedback response information is different from the priority of the second feedback response information and a first transmission resource for transmission of the first feedback response information overlaps a second transmission resource for transmission of the second feedback response information.

In the case where the first transmission resource overlaps the second transmission resource and the priority of the first feedback response information is lower than the priority of the second feedback response information, the terminal device retransmits the second feedback response information in the fourth time unit, and the network device receives the second feedback response information in the fourth time unit. In the case where the first transmission resource overlaps the second transmission resource and the priority of the first feedback response information is higher than the priority of the second feedback response information, the terminal device initially transmits the first feedback response information in the sixth time unit, and the network device receives the first feedback response information in the sixth time unit.

According to the above, in the case where the terminal device needs to initially transmit the first feedback response information and retransmit the second feedback response information, upon reception of the signaling, the terminal device may select to retransmit the second feedback response information in the fourth time unit, i.e., the terminal device performs an operation at 303 and an operation at 304, and/or the terminal device may select to initially transmit the first feedback response information in the sixth time unit, i.e., the terminal device performs an operation at 305 and an operation at 306.

Exemplarily, merely the operation at 303 is performed or merely the operation at 305 is performed, and the operation at 303 and the operation at 305 cannot be both performed. Alternatively, the operation at 303 is performed first and then the operation at 305 is performed in the case where the fourth time unit is later than the sixth time unit. Alternatively, the operation at 305 is performed first and then the operation at 303 is performed in the case where the fourth time unit is no later than the sixth time unit.

At 303, the terminal device retransmits in the fourth time unit the second feedback response information.

After the terminal device determines the fourth time unit, the terminal device retransmits on an available transmission resource the second feedback response information in the fourth time unit. Optionally, the available transmission resource is a PUCCH resource that is available for transmission of feedback response information.

At 304, the network device receives in the fourth time unit the second feedback response information.

Take that the second feedback response information is a retransmitted HARQ-ACK codebook as an example.

For example, the terminal device determines that the fourth time unit is slot n+5 according to the first information. Subsequently, the terminal device retransmits in slot n+5 the HARQ-ACK codebook on the PUCCH resource, and the network device receives the HARQ-ACK codebook in slot n+5.

At 305, the terminal device performs in the sixth time unit initial transmission of the first feedback response information.

After the terminal device determines the sixth time unit, the terminal device initially transmits on the available transmission resource the first feedback response information in the sixth time unit. Optionally, the available transmission resource is a PUCCH resource that is available for transmission of feedback response information.

At 306, the network device receives in the sixth time unit the first feedback response information.

Take that the first feedback response information is an initially-transmitted HARQ-ACK codebook as an example.

For example, the terminal device determines that the sixth time unit is slot n+3 according to the first information. Subsequently, the terminal device initially transmits in slot n+3 the HARQ-ACK codebook on the PUCCH resource, and the network device receives the HARQ-ACK codebook in slot n+3.

Referring to FIG. 11, a flow chart illustrating a method for information feedback is further provided in embodiments of the disclosure. The method is applied in the communication system illustrated in FIG. 1, and in the method, initial transmission of feedback response information and retransmission of feedback response information may both be performed in the same time unit. The method includes the following.

At 401, a network device transmits signaling to a terminal device.

Exemplarily, the signaling is used by the terminal device to determine to retransmit in a fourth time unit second feedback response information. The fourth time unit is configured for initial transmission of first feedback response information.

Configuration signaling for the first feedback response information is separate from configuration signaling for the second feedback response information. Exemplarily, the signaling includes multiple separate configuration signaling respectively for configuring initial transmission of the first feedback response information and retransmission of the second feedback response information.

Optionally, the second feedback response information is initially transmitted in a fifth time unit, and the fifth time unit is no later than the fourth time unit.

Take that the second feedback response information is an HARQ-ACK codebook as an example. The terminal device initially transmits the HARQ-ACK codebook in slot n+1. The terminal device receives in slot n+2 DCI transmitted by the network device, where the DCI is used for instructing the terminal device to retransmit a second HARQ-ACK codebook in slot n+3. The fourth time unit is slot n+3, and the fifth time unit is slot n+1.

At 402, the terminal device receives the signaling.

Exemplarily, for relevant illustrations of the first feedback response information, the second feedback response information, and the time unit, reference may be made to the foregoing illustration, which is not repeated herein.

Optionally, a priority of the first feedback response information is the same as a priority of the second feedback response information. Alternatively, the terminal device supports multiplexing transmission of UCI with different priorities, and the priority of the first feedback response information is different from the priority of the second feedback response information.

At 403, the terminal device performs in the fourth time unit multiplexing transmission of the first feedback response information and the second feedback response information on a physical channel.

After the terminal device determines the fourth time unit, the terminal device initially transmits on an available transmission resource the first feedback response information in the fourth time unit. Optionally, the available transmission resource is a PUCCH resource that is available for transmission of feedback response information.

Optionally, in the fourth time unit, a resource for transmission of the first feedback response information overlaps a resource for transmission of the second feedback response information.

At 404, the network device receives in the fourth time unit the second feedback response information.

Take that the first feedback response information is an initially-transmitted first HARQ-ACK codebook, and the second feedback response information is a retransmitted second HARQ-ACK codebook as an example.

For example, the terminal device determines that the fourth time unit is slot n+5 according to the first information. Subsequently, the terminal device initially transmits on the PUCCH resource the first HARQ-ACK codebook in slot n+5 and retransmits on the PUCCH resource the second HARQ-ACK codebook in slot n+5, and the network device receives in slot n+5 both the first HARQ-ACK codebook and the second HARQ-ACK codebook.

Optionally, the first feedback response information and the second feedback response information are concatenated and then transmitted.

Exemplarily, after the terminal device concatenates the first feedback response information and the second feedback response information, the terminal device performs, in the fourth time unit and on a physical channel, multiplexing transmission of the first feedback response information and the second feedback response information that are concatenated. For example, after the terminal device concatenates the first feedback response information and the second feedback response information, the terminal device transmits, in the fourth time unit and on the same PUCCH resource, the first feedback response information and the second feedback response information that are concatenated.

Exemplarily, referring to FIG. 12, the method provided in embodiments of the disclosure is illustrated by taking that the time unit is a slot, the first feedback response information is an initially-transmitted first HARQ-ACK codebook, and the second feedback response information is a retransmitted second HARQ-ACK codebook as an example.

A shaded part represents an uplink slot, and a blank part represents a downlink slot. It may be seen that slot n+1 and slot n+3 are uplink slots, and the remaining slots are downlink slots.

The terminal device receives in slot n PDSCH configuration information transmitted by the network device, where the configuration information is used by the terminal device to determine that a time unit in which the first HARQ-ACK codebook is initially transmitted is slot n+3. Slot n+3 is the fourth time unit.

The terminal device receives in slot n+2 DCI transmitted by the network device, where the DCI is used to trigger the terminal device to retransmit the second HARQ-ACK codebook in slot n+3. Optionally, take that the second HARQ-ACK codebook is HARQ-ACK codebook 1 as an example. HARQ-ACK codebook 1 is initially transmitted in slot n+1 and is retransmitted in slot n+3.

The terminal device may perform information transmission in slot n+3 in one of the following manners.

Manner 1: the terminal device does not expect to be configured to perform in the same time unit both initial transmission of the first HARQ-ACK codebook and retransmission of the second HARQ-ACK codebook.

Optionally, a priority of the first HARQ-ACK codebook is the same as a priority of the second HARQ-ACK codebook.

The terminal device transmits merely a codebook with a relatively high priority, in the case where the priority of the first HARQ-ACK codebook is different from the priority of the second HARQ-ACK codebook and PUCCH 3 for transmission of the first HARQ-ACK codebook overlaps PUCCH 2 for transmission of the second HARQ-ACK codebook.

Exemplarily, the terminal device initially transmits the first HARQ-ACK codebook in the fourth time unit in the case where the priority of the first HARQ-ACK codebook is higher than the priority of the second HARQ-ACK codebook. The terminal device retransmits the second HARQ-ACK codebook in the sixth time unit in the case where the priority of the first HARQ-ACK codebook is lower than the priority of the second HARQ-ACK codebook. It may be noted herein that the fourth time unit is different from the sixth time unit and is not slot n+3 illustrated in FIG. 12.

For example, the terminal device may initially transmit the first HARQ-ACK codebook in any one uplink slot except slot n+3 in the case where the terminal device retransmits the second HARQ-ACK codebook in slot n+3. Taking that the sixth time unit is slot n+1 as an example, the terminal device may initially transmit the first HARQ-ACK codebook in slot n+1.

Manner 2: the terminal device concatenates the first HARQ-ACK codebook and the second HARQ-ACK codebook in slot n+3, and then transmits on a PUCCH the first HARQ-ACK codebook and the second HARQ-ACK codebook that are concatenated.

Optionally, the priority of the first HARQ-ACK codebook is the same as the priority of the second HARQ-ACK codebook. Alternatively, the priority of the first HARQ-ACK codebook is different from the priority of the second HARQ-ACK codebook, and the terminal device supports multiplexing transmission of UCI with different priorities.

Optionally, in slot n+3, PUCCH 3 for transmission of the first HARQ-ACK codebook overlaps PUCCH 2 for transmission of the second HARQ-ACK codebook.

Exemplarily, in embodiments of the disclosure, the operations performed by the terminal device side may be an embodiment of the method for information feedback applied in the terminal device, and the operations performed by the network device side may be an embodiment of the method for information feedback applied in the network device. For specific illustrations of operations of the method for information feedback, reference may be made to the foregoing content, which may not be repeated herein.

In conclusion, the two technical solutions capable of solving the conflict between initial transmission and retransmission of feedback response information are provided in embodiments of the disclosure. According to the first technical solution, the terminal device does not expect to be configured to perform in the same time unit both initial transmission of the first feedback response information and retransmission of the second feedback response information, and the first feedback response information and the second feedback response information may be transmitted in different time units through scheduling of the network device, thereby simplifying the processing of the terminal device. According to the second technical solution, the terminal device supports performing of initial transmission of the first feedback response information and retransmission of the second feedback response information in the same time unit, thereby improving transmission efficiency.

The following are apparatus embodiments of the disclosure. For details not described in detail in the apparatus embodiments, reference may be made to corresponding illustrations in the foregoing method embodiments, which are not repeated herein.

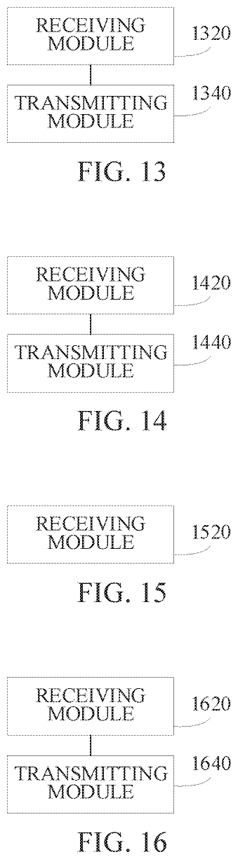

FIG. 13 is a structural diagram illustrating an apparatus for information feedback provided in an exemplary embodiment of the disclosure. The apparatus includes a receiving module 1320 and a transmitting module 1340. The receiving module 1320 is configured to determine a first time unit for transmission of first feedback response information according to configuration information. Deferral transmission of the first feedback response information is supported. The transmitting module 1340 is configured to transmit in a second time unit second feedback response information or transmit in the second time unit both the first feedback response information and the second feedback response information, in the case where no available transmission resource is in the first time unit and the first information instructs the terminal device to retransmit in the second time unit the second feedback response information. The first time unit is the second time unit, or the first time unit is no later than the second time unit.

Optionally, a priority of the first feedback response information is the same as a priority of the second feedback response information, or the terminal device supports multiplexing transmission of UCI with different priorities.

Optionally, the transmitting module 1340 is further configured to defer transmission of the first feedback response information in the case where the second time unit is no later than a maximum feedback deferral position corresponding to the first feedback response information, or to drop the first feedback response information in the case where the second time unit is the maximum feedback deferral position corresponding to the first feedback response information or the second time unit is later than the maximum feedback deferral position corresponding to the first feedback response information.

Optionally, the transmitting module 1340 configured to transmit in the second time unit both the first feedback response information and the second feedback response information is configured to determine a PUCCH resource in the second time unit according to the first feedback response information and the second feedback response information, and transmit on the PUCCH resource both the first feedback response information and the second feedback response information.

Optionally, the second time unit is a maximum feedback deferral position corresponding to the first feedback response information, or the second time unit is no later than the maximum feedback deferral position corresponding to the first feedback response information.

FIG. 14 is a structural diagram illustrating an apparatus for information feedback provided in an exemplary embodiment of the disclosure. The apparatus includes a receiving module 1420 and a transmitting module 1440. The receiving module 1420 is configured to receive second information. The second information is used for instructing the terminal device to retransmit in a third time unit third feedback response information, and the third feedback response information contains fourth feedback response information, where deferral transmission of the fourth feedback response information is supported. The transmitting module 1440 is configured to transmit in the third time unit the third feedback response information, or transmit in the third time unit other information excluding the fourth feedback response information in the third feedback response information.

Optionally, the third feedback response information contains non-deferred feedback response information and deferred feedback response information, and the fourth feedback response information is the deferred feedback response information.

Optionally, the fourth feedback response information is feedback response information a maximum feedback deferral position corresponding to which is no later than the third time unit.

FIG. 15 is a structural diagram illustrating an apparatus for information feedback provided in an exemplary embodiment of the disclosure. The apparatus includes a receiving module 1520. The receiving module 1520 is configured to receive signaling and determine to retransmit in a fourth time unit second feedback response information. The fourth time unit is not configured for initial transmission of first feedback response information.

Optionally, the second feedback response information is initially transmitted in a fifth time unit, where the fifth time unit is no later than the fourth time unit.

Optionally, initial transmission of the first feedback response information is performed in a sixth time unit, where the sixth time unit is different from the fourth time unit.

Optionally, a priority of the first feedback response information is the same as a priority of the second feedback response information. Alternatively, the terminal device supports multiplexing transmission of UCI with different priorities, and the priority of the first feedback response information is different from the priority of the second feedback response information.

FIG. 16 is a structural diagram illustrating an apparatus for information feedback provided in an exemplary embodiment of the disclosure. The apparatus includes a receiving module 1620 and a transmitting module 1640. The receiving module 1620 is configured to receive signaling and determine to retransmit in a fourth time unit second feedback response information. The fourth time unit is configured for initial transmission of first feedback response information. The transmitting module 1640 is configured to perform on a physical channel multiplexing transmission of the first feedback response information and the second feedback response information.

Optionally, the second feedback response information is initially transmitted in a fifth time unit, where the fifth time unit is no later than the fourth time unit.

Optionally, the transmitting module 1640 is configured to perform, in the fourth time unit and on a physical channel, multiplexing transmission, of the first feedback response information and the second feedback response information that are concatenated.

Optionally, a priority of the first feedback response information is the same as a priority of the second feedback response information. Alternatively, the terminal device supports multiplexing transmission of UCI with different priorities, and the priority of the first feedback response information is different from the priority of the second feedback response information.

Optionally, in the fourth time unit, a resource for transmission of the first feedback response information overlaps a resource for transmission of the second feedback response information.

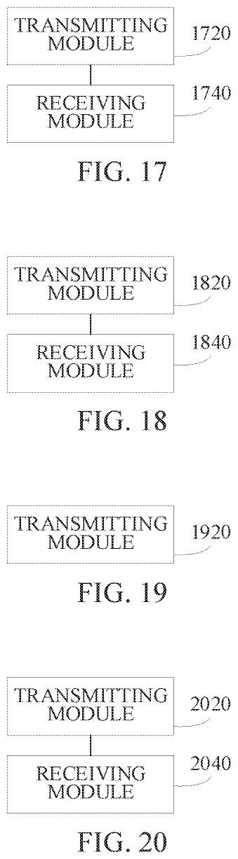

FIG. 17 is a structural diagram illustrating an apparatus for information feedback provided in an exemplary embodiment of the disclosure. The apparatus includes a transmitting module 1720 and a receiving module 1740. The transmitting module 1720 is configured to transmit configuration information. The configuration information is used by a terminal device to determine a first time unit for transmission of first feedback response information. Deferral transmission of the first feedback response information is supported. The transmitting module 1720 is further configured to transmit first information. The first information is used for instructing the terminal device to retransmit in a second time unit second feedback response information. The receiving module 1740 is configured to receive in the second time unit the second feedback response information, where the second feedback response information is transmitted by the terminal device in the case where no available transmission resource is in the first time unit and the first information instructs the terminal device to retransmit in the second time unit the second feedback response information; or to receive in the second time unit both the first feedback response information and the second feedback response information, where the first feedback response information and the second feedback response information are transmitted by the terminal device in the case where no available transmission resource is in the first time unit and the first information instructs the terminal device to retransmit in the second time unit the second feedback response information. The first time unit is the second time unit, or the first time unit is no later than the second time unit.

Optionally, a priority of the first feedback response information is the same as a priority of the second feedback response information, or the terminal device supports multiplexing transmission of UCI with different priorities.

Optionally, the receiving module 1740 configured to receive in the second time unit both the first feedback response information and the second feedback response information is configured to receive, in the second time unit and on a PUCCH resource, both the first feedback response information and the second feedback response information. The PUCCH resource is determined according to the first feedback response information and the second feedback response information.

Optionally, the second time unit is a maximum feedback deferral position corresponding to the first feedback response information, or the second time unit is no later than the maximum feedback deferral position corresponding to the first feedback response information.

FIG. 18 is a structural diagram illustrating an apparatus for information feedback provided in an exemplary embodiment of the disclosure. The apparatus includes a transmitting module 1820 and a receiving module 1840. The transmitting module 1820 is configured to transmit second information. The second information is used for instructing a terminal device to retransmit in a third time unit third feedback response information. The third feedback response information contains fourth feedback response information, where deferral transmission of the fourth feedback response information is supported. The receiving module 1840 is configured to receive in the third time unit the third feedback response information, or receive in the third time unit other information excluding the fourth feedback response information in the third feedback response information.

Optionally, the third feedback response information contains non-deferred feedback response information and deferred feedback response information, and the fourth feedback response information is the deferred feedback response information.

Optionally, the fourth feedback response information is feedback response information a maximum feedback deferral position corresponding to which is no later than the third time unit.

FIG. 19 is a structural diagram illustrating an apparatus for information feedback provided in an exemplary embodiment of the disclosure. The apparatus includes a transmitting module 1920. The transmitting module 1920 is configured to transmit signaling. The signaling is used by a terminal device to determine to retransmit in a fourth time unit second feedback response information. The fourth time unit is not configured for initial transmission of first feedback response information.

Optionally, the second feedback response information is initially transmitted in a fifth time unit, where the fifth time unit is no later than the fourth time unit.

Optionally, initial transmission of the first feedback response information is performed in a sixth time unit, where the sixth time unit is different from the fourth time unit.

Optionally, a priority of the first feedback response information is the same as a priority of the second feedback response information. Alternatively, the terminal device supports multiplexing transmission of UCI with different priorities, and the priority of the first feedback response information is different from the priority of the second feedback response information.

FIG. 20 is a structural diagram illustrating an apparatus for information feedback provided in an exemplary embodiment of the disclosure. The apparatus includes a transmitting module 2020 and a receiving module 2040. The transmitting module 2020 is configured to transmit signaling. The signaling is used by a terminal device to determine to retransmit in a fourth time unit second feedback response information. The fourth time unit is used for initial transmission of first feedback response information. The receiving module 2040 is configured to receive in the fourth time unit the second feedback response information, where the first feedback response information and the second feedback response information are multiplexed and transmitted on a physical channel.

Optionally, the second feedback response information is initially transmitted in a fifth time unit, where the fifth time unit is no later than the fourth time unit.

Optionally, the receiving module 2040 is configured to receive the first feedback response information and the second feedback response information that are concatenated, where the first feedback response information and the second feedback response information that are concatenated are multiplexed and transmitted on a physical channel.

Optionally, a priority of the first feedback response information is the same as a priority of the second feedback response information. Alternatively, the terminal device supports multiplexing transmission of UCI with different priorities, and the priority of the first feedback response information is different from the priority of the second feedback response information.

Optionally, in the fourth time unit, a resource for transmission of the first feedback response information overlaps a resource for transmission of the second feedback response information.

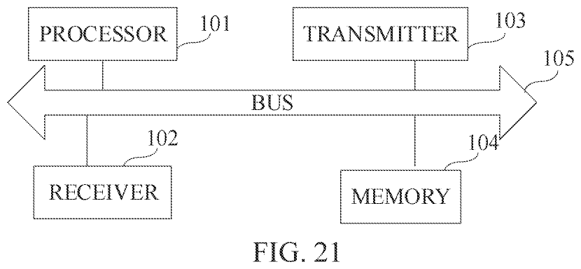

FIG. 21 is a schematic structural diagram illustrating a communication device (e.g., a terminal device or a network device) provided in an exemplary embodiment of the disclosure. The communication device includes a processor 101, a receiver 102, a transmitter 103, a memory 104, and a bus 105.

The processor 101 includes one or more processing cores and is configured to perform various functional applications and information processing by executing software programs and modules.

The receiver 102 and the transmitter 103 may be implemented as a communication assembly, where the communication assembly may be a communication chip.

The memory 104 is coupled with the processor 101 via the bus 105.

The memory 104 is configured to store at least one instruction, and the processor 101 is configured to execute the at least one instruction to implement various operations in the foregoing method implementations.

In addition, the memory 104 may be implemented as a volatile or a non-volatile storage device or a combination thereof, where the volatile or a non-volatile storage device includes, but is not limited to, a magnetic disc or an optical disc, an electrically-erasable programmable read-only memory (EEPROM), an erasable programmable read-only memory (EPROM), a static random access memory (SRAM), a read-only memory (ROM), a magnetic memory, a flash memory, or a programmable read-only memory (PROM).

Exemplarily, a computer device is further provided in embodiments of the disclosure. The computer device includes a processor and a memory. The memory is configured to store at least one program code. The at least one program code is loaded and executed by the processor to implement the method for information feedback.

Exemplarily, a computer-readable storage medium is further provided in embodiments of the disclosure. The computer-readable storage medium is configured to store at least one program code. The at least one program code is loaded and executed by a processor to implement the method for information feedback.

Exemplarily, a computer program product is further provided in embodiments of the disclosure. The computer program product includes a computer program stored in a computer-readable storage medium. A processor of a computer device is configured to read the computer program from the computer-readable storage medium and then execute the computer program which enables the computer device to implement the method for information feedback.

According to an aspect of the disclosure, a chip is provided. The chip includes a programmable logic circuit or a program. The chip is configured to implement the method for information feedback.

It may be understood that the term “multiple” or “a plurality of” involved herein indicates two or more than two. The term “and/or” in this disclosure is simply an illustration of an association relationship of associated objects, indicating that three relationships may exist, for example, A and/or B, which may indicate the existence of A alone, A and B together, and B alone. In addition, the character “/” in this disclosure generally indicates that associated objects are in an “or” relationship.

It will be understood by those of ordinary skill in the art that all or part of the above implementations may be accomplished by means of hardware or a program to instruct associated hardware, and the program may be stored in a computer-readable storage medium which may be an ROM, a magnetic disc, or an optical disc.

The above are merely optional implementations of the disclosure and are not intended to limit the disclosure. Any modification, equivalent arrangements, and improvement made within the spirit and principles of the disclosure shall be included in the scope of protection of the disclosure.

What is claimed is:

1. A method for information feedback, the method being applied in a terminal device and comprising:
determining a first time unit for transmission of first feedback response information according to configuration information, wherein deferral transmission of the first feedback response information is supported; and
transmitting in a second time unit second feedback response information or transmitting in the second time unit both the first feedback response information and the second feedback response information, in the case where no available transmission resource is in the first time unit and first information instructs the terminal device to retransmit in the second time unit the second feedback response information;
wherein the first time unit is the second time unit, or the first time unit is no later than the second time unit.

2. The method of claim 1, wherein:
a priority of the first feedback response information is the same as a priority of the second feedback response information; or
the terminal device supports multiplexing transmission of uplink control information (UCI) with different priorities.

3. The method of claim 1, wherein in the case of transmitting in the second time unit the second feedback response information, the method further comprises:
deferring transmission of the first feedback response information, in the case where the second time unit is no later than a maximum feedback deferral position corresponding to the first feedback response information; or
dropping the first feedback response information, in the case where the second time unit is the maximum feedback deferral position corresponding to the first feedback response information or the second time unit is later than the maximum feedback deferral position corresponding to the first feedback response information.

4. The method of claim 1, wherein transmitting in the second time unit both the first feedback response information and the second feedback response information comprises:
determining a physical uplink control channel (PUCCH) resource in the second time unit according to the first feedback response information and the second feedback response information; and
transmitting on the PUCCH resource both the first feedback response information and the second feedback response information.

5. The method of claim 1, wherein the second time unit is a maximum feedback deferral position corresponding to the first feedback response information, or the second time unit is no later than the maximum feedback deferral position corresponding to the first feedback response information.

6. A terminal device, comprising:
a transceiver;
a processor coupled to the transceiver; and
a memory storing a computer program which, when executed by the terminal device, causes the terminal device to:
determine a first time unit for transmission of first feedback response information according to configuration information, wherein deferral transmission of the first feedback response information is supported; and
transmit in a second time unit second feedback response information or transmit in the second time unit both the first feedback response information and the second feedback response information, in the case where no available transmission resource is in the first time unit and first information instructs the terminal device to retransmit in the second time unit the second feedback response information;
wherein the first time unit is the second time unit, or the first time unit is no later than the second time unit.

7. The terminal device of claim 6, wherein:
a priority of the first feedback response information is the same as a priority of the second feedback response information; or
the terminal device supports multiplexing transmission of uplink control information (UCI) with different priorities.

8. The terminal device of claim 6, wherein the computer program is further executed by the processor to cause the terminal device to perform the following in the case of transmitting in the second time unit the second feedback response information:
deferring transmission of the first feedback response information, in the case where the second time unit is no later than a maximum feedback deferral position corresponding to the first feedback response information; or
dropping the first feedback response information, in the case where the second time unit is the maximum feedback deferral position corresponding to the first feedback response information or the second time unit is later than the maximum feedback deferral position corresponding to the first feedback response information.

9. The terminal device of claim 6, wherein the computer program executed by the processor to cause the terminal device to transmit in the second time unit both the first feedback response information and the second feedback response information is executed by the processor to cause the terminal device to:
determine a physical uplink control channel (PUCCH) resource in the second time unit according to the first feedback response information and the second feedback response information; and
transmit on the PUCCH resource both the first feedback response information and the second feedback response information.

10. The terminal device of claim 6, wherein the second time unit is a maximum feedback deferral position corresponding to the first feedback response information, or the second time unit is no later than the maximum feedback deferral position corresponding to the first feedback response information.

11. A network device, comprising:
a transceiver;
a processor coupled to the transceiver; and
a memory storing a computer program which, when executed by the processor, causes the network device to:
transmit configuration information, wherein the configuration information is used by a terminal device to determine a first time unit for transmission of first feedback response information, wherein deferral transmission of the first feedback response information is supported;
transmit first information, wherein the first information is used for instructing the terminal device to retransmit in a second time unit second feedback response information; and
receive in the second time unit the second feedback response information, wherein the second feedback response information is transmitted by the terminal device in the case where no available transmission resource is in the first time unit and the first information instructs the terminal device to retransmit in the second time unit the second feedback response information; or receive in the second time unit both the first feedback response information and the second feedback response information, wherein both the first feedback response information and the second time unit are transmitted by the terminal device in the case where no available transmission resource is in the first time unit and the first information instructs the terminal device to retransmit the second feedback response information in the second time unit;
wherein the first time unit is the second time unit, or the first time unit is no later than the second time unit.

12. The network device of claim 11, wherein:
a priority of the first feedback response information is the same as a priority of the second feedback response information; or
the terminal device supports multiplexing transmission of uplink control information (UCI) with different priorities.

13. The network device of claim 11, wherein the computer program executed by the processor to cause the network device to receive in the second time unit both the first feedback response information and the second feedback response information is executed by the processor to cause the network device to:
receive, in the second time unit and on a physical uplink control channel (PUCCH) resource, both the first feedback response information and the second feedback response information, wherein the PUCCH resource is determined according to the first feedback response information and the second feedback response information.

14. The network device of claim 11, wherein the second time unit is a maximum feedback deferral position corresponding to the first feedback response information, or the second time unit is no later than the maximum feedback deferral position corresponding to the first feedback response information.
